(19) United States
(12) Patent Application Publication
(10) Pub. No.: US 2024/0162481 A1
(43) Pub. Date: May 16, 2024

(54) COMPOSITION FOR SOLID STATE ELECTROLYTE AND METHOD FOR PREPARING SAME

(71) Applicants: INDUSTRY-ACADEMIC COOPERATION FOUNDATION OF SUNCHON NATIONAL UNIVERSITY, Suncheon-si (KR); INDUSTRY ACADEMY COOPERATION FOUNDATION OF SEJONG UNIVERSITY, Seoul (KR)

(72) Inventors: Kee Sun SOHN, Seoul (KR); Myoung Ho PYO, Suncheon-si (KR); Woon Bae PARK, Suncheon-si (KR); Jung Yong SEO, Suncheon-si (KR)

(21) Appl. No.: 18/381,295

(22) Filed: Oct. 18, 2023

(30) Foreign Application Priority Data
Oct. 19, 2022 (KR) 10-2022-0135005

(51) Int. Cl. H01M 10/0562

(52) U.S. Cl. CPC H01M 10/0562; H01M 2300/008

(57) ABSTRACT

The present invention relates to a solid electrolyte composition and a method for preparing the same. A solid electrolyte composition according to the present invention is characterized by including a material represented by [Formula 1] below.

NaₐW_{b}Si_{c}Sb_{d}SₑBr_{f} [Equation 1]
(Here, 2.80≤a≤2.89, 0.20≤b≤0.24, 0.08≤c≤0.12, 0.66≤d≤0.70, 3.91≤e≤4, and 0≤f≤0.09.)

### BACKGROUND OF THE INVENTION

### 1. Field of the Invention

The present invention relates to a solid electrolyte composition and a method for preparing the same.

### 2. Description of the Related Art

Oxide solid electrolytes represented by NASICON and β/β″-alumina have properties of easily diffusing Na⁺ ions, and thus, are applied to commercial energy storage systems in high-temperature environments (245° C. to 300° C.).

The room-temperature ionic conductivity (σion) of such an oxide solid electrolyte may reach a level close to the ionic conductivity of a liquid electrolyte. However, such high room-temperature ionic conductivity may be obtained when a densified pellet is sintered at a high temperature (1200° C. to 1600° C.) that reduces grain boundary resistance, which makes it difficult for the oxide solid electrolyte to be applied to commercial secondary batteries for everyday use.

The problem may be reduced by using a sulfide-based solid electrolyte, which is soft and easily deformable, so that a cold-pressing method may be applied thereto without consideration of serious interfacial resistance.

Na₃PS₄ is a solid electrolyte which conducts Na⁺ ions at room temperature, and is a typical sulfide solid electrolyte with a room-temperature ionic conductivity (σion) of about 1 mS/cm. In order to improve the ionic conductivity of the compound to a level comparable to that of a liquid electrolyte, various compositional changes have been studied. However, the room-temperature ionic conductivity (σion) of Na₃PS₄ has a lot of room for improvement.

### PRIOR ART DOCUMENT

### Patent document

(Patent Document 0001) Chinese Patent Laid-Open Publication No. 113363570

### SUMMARY OF THE INVENTION

The purpose of the invention is to provide a sulfide-based solid electrolyte composition having excellent ionic conductivity at room temperature and/or low temperatures and a method for preparing the composition.

According to an aspect of the invention, there is provided a solid electrolyte composition including a material represented by [Formula 1] below.

NaₐW_{b}Si_{c}Sb_{d}SₑBr_{f} [Equation 1]
(Here, 2.80≤a≤2.89, 0.20≤b≤0.24, 0.08≤c≤0.12, 0.66≤d≤0.70, 3.91≤e≤4, and 0≤f≤0.09.)

According to another aspect of the invention, there is provided a method for preparing a solid electrolyte composition including a material represented by [Formula 1] below, wherein the method includes
(a) mixing raw materials,
(b) heating the mixed materials to a predetermined temperature and maintaining the same for a predetermined period of time, and
(c) cooling the heated materials.

NaₐW_{b}Si_{c}Sb_{d}SₑBr_{f} [Equation 1]
(Here, 2.80≤a≤2.89, 0.20≤b≤0.24, 0.08≤c≤0.12, 0.66≤d≤0.70, 3.91≤e≤4, and 0≤f≤0.09.)

### ADVANTAGEOUS EFFECTS

A sulfide-based solid electrolyte composition according to the invention exhibits good room-temperature ionic conductivity of 15.0 mS/cm or greater.

In addition, the sulfide-based solid electrolyte composition according to an embodiment of the invention has excellent ionic conductivity even at a low temperature of −20° C., so that the sulfide-based solid electrolyte composition according to an embodiment of the present invention may be used in more diverse environments.

In addition, a method for preparing a sulfide-based solid electrolyte composition according to the invention is economical since good room-temperature and low-temperature ionic conductivity may be implemented without having to apply a high-cost process, such as a ball mill process or a pellet sintering process.

### BRIEF DESCRIPTION OF THE DRAWINGS

FIG. 1 is the result of XRD analysis of a solid electrolyte composition according to an embodiment of the invention;

FIG. 2A is the result of structure properties analysis of a solid electrolyte composition according to an embodiment of the invention, and FIG. 2B shows the distribution of Na⁺ in the cubic phase;

FIG. 3 is an EIS spectrum of a solid electrolyte composition according to an embodiment of the invention; and

FIG. 4A is an Arrhenius plot of ionic conductivity, FIG. 4B is a steady-state current plot(the inserted figure shows a transient current at 0.4 V) at various DC polarizations for the determination of σe, and FIG. 4C shows a voltage fluctuation during constant-current Na plating/stripping.

### DETAILED DESCRIPTION OF THE EXEMPLARY EMBODIMENTS

Hereinafter, embodiments of the present invention will be described in detail with reference to the accompanying drawings.

However, the embodiments of the present invention illustrated below may be modified into other various forms, and the scope of the present invention is not limited to the embodiments described below. The embodiments of the present invention are provided to more fully describe the present invention to those skilled in the art.

A solid electrolyte composition according to the present invention is characterized by including a material represented by [Formula 1] below.

NaₐW_{b}Si_{c}Sb_{d}SₑBr_{f} [Equation 1]
(Here, 2.80≤a≤2.89, 0.20≤b≤0.24, 0.08≤c≤0.12, 0.66≤d≤0.70, 3.91≤e≤4, and 0≤f≤0.09.)

When the contents of Na, W, Si, Sb, S, and Br described in [Equation 1] above are out of the ranges, it is difficult to obtain the excellent room-temperature or low-temperature ionic conductivity desired by the invention, so that it is desirable to maintain the above ranges.

In the solid electrolyte composition, the space group of the material represented by [Equation 1] above may be 143 m.

In the solid electrolyte composition, the material represented by [Equation 1] above may have an ionic conductivity σion at room temperature(25° C.) of 15.0 mS/cm or greater, preferably, an ionic conductivity σion at room temperature(25° C.) of 17.0 mS/cm or greater, more preferably, an ionic conductivity σion at room temperature(25° C.) of 19.0 mS/cm or greater, and most preferably, an ionic conductivity σion at room temperature(25° C.) of 20.0 mS/cm or greater.

In the solid electrolyte composition, the material represented by [Equation 1] above may have an ionic conductivity σion at a low temperature(−20° C.) of 3.5 mS/cm or greater, preferably, an ionic conductivity σion at a low temperature(−20° C.) of 4.5 mS/cm or greater, more preferably, an ionic conductivity σion at a low temperature(−20° C.) of 5.5 mS/cm or greater, and most preferably, an ionic conductivity σion at a low temperature(−20° C.) of 6.5 mS/cm or greater.

In the material represented by [Equation 1] above, a may be 2.87 to 2.89, and f may be 0. That is, Br may not be substantially included.

In the solid electrolyte composition, the crystal structure of the material represented by [Equation 1] above may be cubic.

The method for preparing a solid electrolyte composition according to the invention is to prepare the aforementioned solid electrolyte composition, and
is a method for preparing a solid electrolyte composition including a material represented by [Equation 1] below, wherein the method is characterized by including
(a) mixing raw materials,
(b) heating the mixed materials to a predetermined temperature and maintaining the same for a predetermined period of time, and
(c) cooling the heated materials.

NaₐW_{b}Si_{c}Sb_{d}SₑBr_{f} [Equation 1]
(Here, 2.80≤a≤2.89, 0.20≤b≤0.24, 0.08≤c≤0.12, 0.66≤d≤0.70, 3.91≤e≤4, and 0≤f≤0.09.)

In the method for preparing a solid electrolyte composition, any of various known methods for mixing powder may be used as the mixing method.

In the method for preparing a solid electrolyte composition, it is preferable that the step (b) above is performed at 275° C. to 575° C. for 12 hours to 48 hours.

When the heating temperature is lower than 275° C., the raw materials may remain in the raw material state even after a synthesis process since the synthesis is not achieved due to a low heating temperature, and when higher than 575° C., there is a possibility in that a solid electrolyte is synthesized in an orthorhombic phase rather than a cubic phase, so that it is preferable to maintain the temperature in the range of 275° C. to 575° C.

When the heating time is less than 12 hours, smooth synthesis of a reactant is degraded due to insufficient heating time, and when greater than 48 hours, a chemical reaction may occur between the reactant and a quartz tube, thereby producing a synthesized product different from the solid electrolyte, so that it is preferable to maintain the heating time in the rage of 12 hours to 48 hours.

### EXAMPLE 1

In about 1 g of a reactant, a raw material Na₂S (Alfa-aesar) has a composition ratio of 34.23 wt %, a raw material Sb₂S₃ (synthesized product) has a composition ratio of 36.98 wt %, a raw material Si (Sigma-aldrich) has a composition ratio of 0.90 wt %, a raw material W (Sigma-aldrich) has a composition ratio of 9.78 wt %, a raw material S (Sigma-aldrich) has a composition ratio of 15.81 wt %, and a raw material NaBr(Sigma-aldrich) has a composition ratio of 2.30 wt %. The raw materials used for synthesis in all embodiments had a purity of 99% or greater and were used as purchased without any further purification.

First, a stainless steel ball (10 mm) and about 1 g of the reactant were placed together in a stainless steel pot for a ball mill grinder (PULVERISETTE 23, FRISTCH) to be ground for 5 minutes at a frequency of 40 Hz, and then the ground powder was put into a quartz tube.

The entire process was performed in a glove box filled with argon. Each quartz tube was closed with a quartz stopper, taken out of the glove box, and immediately connected to a vacuum sealer (NBD-DXZ-02, Nobody Sci. Tech. Co.). Thereafter, the sealed tube was placed in a box furnace, heated (3° C./min) to a temperature of 575° C., and maintained for 12 hours, and then the quartz tube was taken out and cooled in the surrounding atmosphere to synthesize a solid electrolyte composition. Through the above, a material having a composition of Na_{2.81} (W_{0.22}Si_{0.10}Sb_{0.68})S_{3.93}Br_{0.07} was obtained.

### EXAMPLE 2

In about 1 g of a reactant, a raw material Na₂S (Alfa-aesar) has a composition ratio of 34.79 wt %, a raw material Sb₂S₃ (synthesized product) has a composition ratio of 37.04 wt %, a raw material Si (Sigma-aldrich) has a composition ratio of 0.90 wt %, a raw material W (Sigma-aldrich) has a composition ratio of 9.79 wt %, a raw material S (Sigma-aldrich) has a composition ratio of 15.83 wt %, and a raw material NaBr (Sigma-aldrich) has a composition ratio of 1.65 wt %. The raw materials used for synthesis in all embodiments had a purity of 99% or greater and were used as purchased without any further purification.

A material having a composition of Na_{2.83} (W_{0.22}Si_{0.10}Sb_{0.68})S_{3.95}Br_{0.05} was obtained through the same process as in Example 1 using these raw materials.

### EXAMPLE 3

In about 1 g of a reactant, a raw material Na₂S (Alfa-aesar) has a composition ratio of 35.49 wt %, a raw material Sb₂S₃ (synthesized product) has a composition ratio of 37.25 wt %, a raw material Si (Sigma-aldrich) has a composition ratio of 0.91 wt %, a raw material W (Sigma-aldrich) has a composition ratio of 9.85 wt %, a raw material S (Sigma-aldrich) has a composition ratio of 15.51 wt %, and a raw material NaBr (Sigma-aldrich) has a composition ratio of 0.99 wt %. The raw materials used for synthesis in all embodiments had a purity of 99% or greater and were used as purchased without any further purification.

A material having a composition of Na_{2.83} (W_{0.22}Si_{0.10}Sb_{0.68}) S_{3.95}Br_{0.05} was obtained through the same process as in Example 1 using these raw materials.

### EXAMPLE 4

In about 1 g of a reactant, a raw material Na₂S (Alfa-aesar) has a composition ratio of 36.18 wt %, a raw material Sb₂S₃ (synthesized product) has a composition ratio of 37.19 wt %, a raw material Si (Sigma-aldrich) has a composition ratio of 0.90 wt %, a raw material W (Sigma-aldrich) has a composition ratio of 9.83 wt %, and a raw material S (Sigma-aldrich) has a composition ratio of 15.90 wt %. The raw materials used for synthesis in all embodiments had a purity of 99% or greater and were used as purchased without any further purification.

A material having a composition of Na_{2.88}(W_{0.22}Si_{0.10}Sb_{0.68})S₄ was obtained through the same process as in Example 1 using these raw materials.

### XRD Analysis

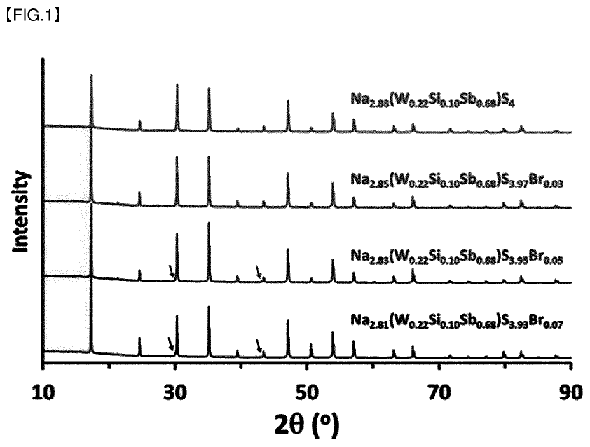

XRD analysis was performed on the solid electrolyte compositions synthesized by Examples 1 to 4. The XRD peaks in FIG. 1 were obtained using a Rigaku ULTIMA4 diffractometer having a Cu Ka radiation source at a scan rate of 3°/min.

As confirmed in FIG. 1, Example 4 in which Br was not included showed a pure phase without peaks due to impurities compared to Examples 1 to 3 in which Br was doped in a small amount.

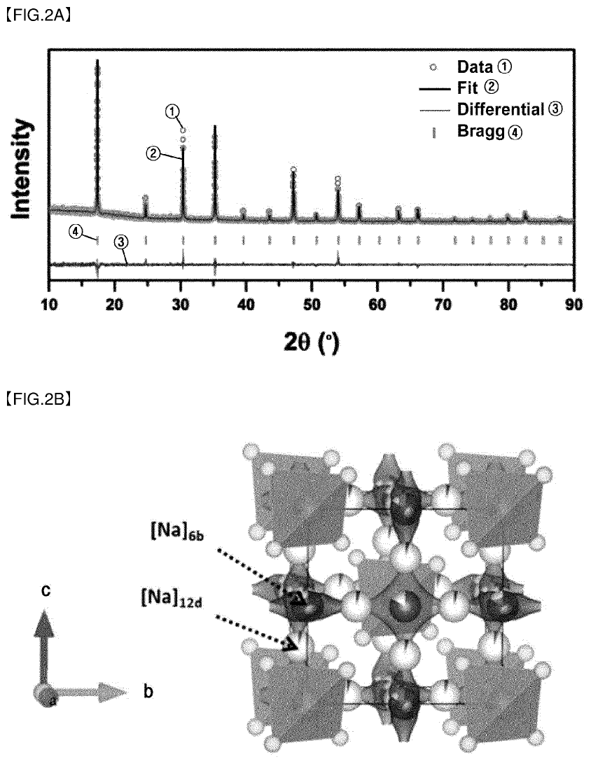

As shown in FIG. 2(A), as a result of confirming the XRD pattern using the Rietveld method, it was confirmed that the crystal structure of each of Examples 1 to 4 had a cubic structure.

FIG. 2A is the result of structure properties analysis of the solid electrolyte composition according to Example 4, and FIG. 2B shows the distribution of Na⁺ in the cubic phase. In the structure analysis, the crystallography information of ICSD 44707 was used including the possible Na⁺ occupancy at the 12d site, and the relative occupancy between the 6b site and 12d site was variously allowed without limitation. The result of the analysis showed that the best fit was achieved when a small amount of Na⁺ was present at the 12d site. Refined parameters, such as the lattice dimensions, atomic coordinates, and site occupancy, of Example 4, are shown in Table 1 below.

TABLE 1

| | Wyckoff | | | | | |
|---|---|---|---|---|---|---|
| | symbol | | | | | |
| | (Wyckoff | | | | | |
| Atom | symbol) | x/a | y/b | z/c | U (Å²) | SOF |
| Na | 6b | 0 | 0 | 0.5 | 0.164 (9) | 0.85 (3) |
| Na | 12d | 0.75 | 0.5 | 0 | 0.17 (10) | 0.057 (16) |
| Sb | 2a | 0 | 0 | 0 | 0.1165 (11) | 0.680 |
| Si | 2a | 0 | 0 | 0 | 0.1165 (11) | 0.100 |
| W | 2a | 0 | 0 | 0 | 0.1165 (11) | 0.220 |
| S | 8c | 0.1885 (5) | 0.1885 (5) | 0.1885 (5) | 0.114 (3) | 1.000 |

Space group: I-43 m
Number of formulas per unit cell 1 (z) = 2
Lattice constant s: a = 7.20169 (7) Å, c = 7.2979 (1) Å, α = β = η = 90°
Agreement factor: Rp = 11.2, Rwp = 15.1, Rexp = 14.82 [symbol] γ² = 1.03

The 12d site is positioned halfway between the 6b site, and is considered to be a transition state of a diffusion pathway which may be visualized on a bond-valence energy-landscape (BVEL) map. FIG. 2B shows that an equivalent surface of 1.5 eV is connected in a three-dimensional direction and partially filled with Na⁺ at the 12d site position to promote Na⁺ diffusion.

### EIS Analysis

Samples prepared for the EIS measurement of the solid electrolyte compositions synthesized by Examples 1 to 4 were completely ground for 10 minutes, sandwiched between two stainless discs, and then made into a pellet in a polyoxymethylen (POM) mold at a pressure of 360 MPa.

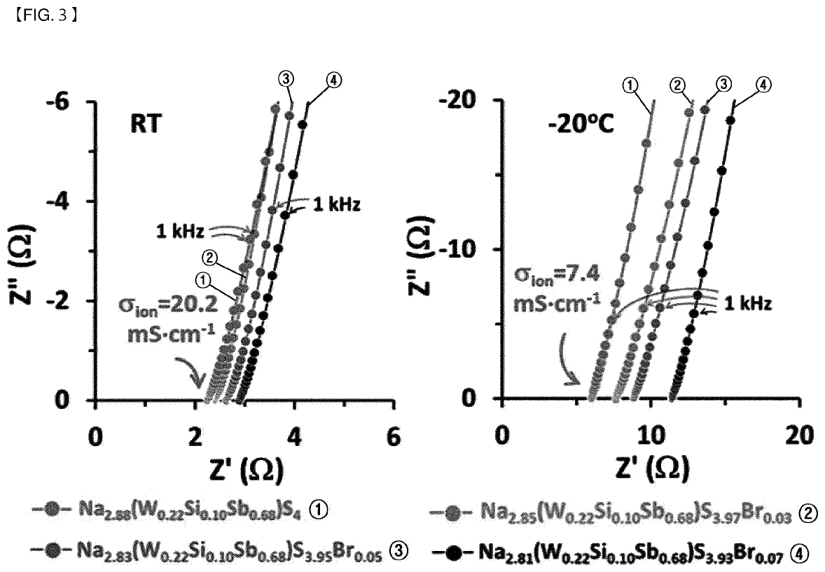

An EIS spectrum of the pellet (area: 1.33 cm², thickness: about 280 μm to 860 μm) was obtained at an amplitude of 10 mV in the frequency range of 0.1 Hz and 10⁶ Hz (ZIVE SP2, WonATech), and the results are shown in FIG. 3.

The current of each sample was monitored for 25 minutes at various potentials to determine electronic conductivity. Also, a steady-state current value was used to calculate the electronic conductivity.

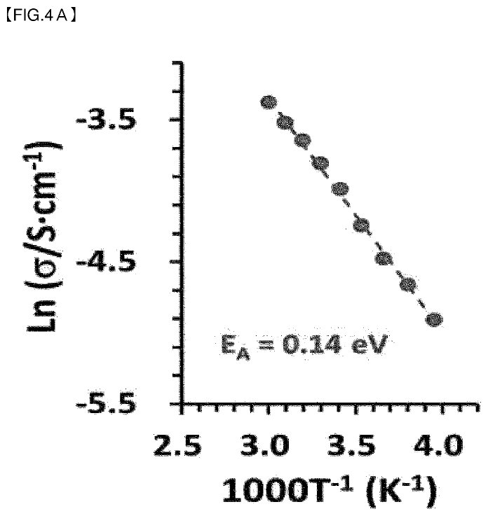

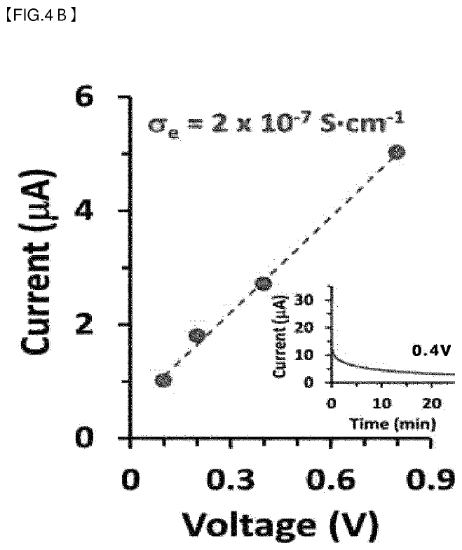

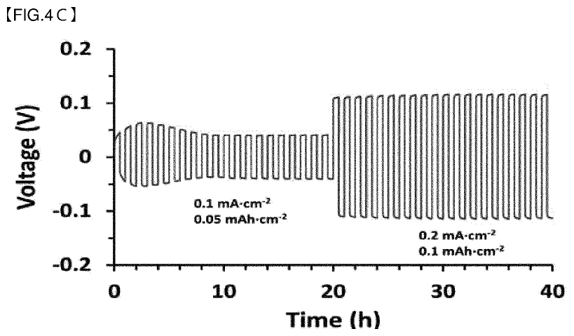

FIG. 4A is an Arrhenius plot of ionic conductivity, and FIG. 4B is a steady-state current plot (the inserted figure shows a transient current at 0.4 V) at various DC polarizations for the determination of σe, and Table 2 below shows the room-temperature ionic conductivity measured in the solid electrolyte compositions according to each of Examples 1 to 4.

TABLE 2

| | | Room- | Low- |
|---|---|---|---|
| | | tem- | tem- |
| | | pera- | pera- |
| | | ture(25° | ture(−20° |
| | | C.) | C.) |
| | | ionic | ionic |
| | | conduc- | conduc- |
| Classifi- | | tivity | tivity |
| cation | Composition | (mS/cm) | (mS/cm) |
| Example 1 | Na_{2.81}(W_{0.22}Si_{0.10}Sb_{0.68})S_{3.93}Br_{0.07} | 15.3 | 3.8 |
| Example 2 | Na_{2.83}(W_{0.22}Si_{0.10}Sb_{0.68})S_{3.95}Br_{0.05} | 16.8 | 4.9 |
| Example 3 | Na_{2.85}(W_{0.22}Si_{0.10}Sb_{0.68})S_{3.97}Br_{0.03} | 18.4 | 5.7 |
| Example 4 | Na_{2.88}(W_{0.22}Si_{0.10}Sb_{0.68})S₄ | 20.2 | 7.4 |

As confirmed in Table 2, the room-temperature ionic conductivity of Examples 1 to 4 of the invention is about 15 mS/cm or greater, which exhibits higher ionic conductivity than that of a solid electrolyte composition having the highest ionic conductivity reported to date when a high-cost process is not applied.

As the doping amount of Br decreases from Example 1 to Example 3, the ionic conductivity thereof improves, wherein the ionic conductivity of Example 4, in which Br is not included, shows the highest value, and as confirmed in the above structure analysis, the trend seems to be due to a decrease in impurity phases due to a decrease in the doping amount of bromine (Br), and due to a structure capable of promoting Na⁺ diffusion.

Particularly, Example 4 exhibits good ionic conductivity of 7.4 mS/cm even at a low temperature of −20° C., which is a property that increases the possibility of the solid electrolyte composition according to Example 4 being applied under various environments.

In addition, as expected from the high ionic conductivity at a low temperature of −20° C., the activation barrier of Na⁺ diffusion appears to be substantially low. From the Arrhenius plot (FIG. 4A) of ionic conductivity measured between −20° C. and 60° C., Example 4 was found to have an EA of 0.14 eV, and the EA of Example 4 is significantly lower than the EA of 0.18 eV to 0.22 eV reported in Na_{˜2.9} (−W_{˜0.9}Sb_{˜0.9})S₄ doped with W.

In order to confirm the electrochemical stability of the solid electrolyte composition according to Example 4 of the invention, a pellet subjected to cold-pressing at a pressure of 370 MPa was sandwiched between Na₁₅Sn₄ layers, and then pressurized in a POM mold (10 kPa) to manufacture a symmetric cell.

FIG. 4C shows a voltage fluctuation during constant-current Na plating/stripping of the symmetric cell. As confirmed in FIG. 4C, the symmetric cell exhibited a stable Na plating/stripping behavior.

What is claimed is:

1. A solid electrolyte composition comprising a material represented by [Equation 1] below:
NaₐW_{b}Si_{c}Sb_{d}SₑBr_{f} [Equation 1]
(wherein, 2.80≤a≤2.89, 0.20≤b≤0.24, 0.08≤c≤0.12, 0.66≤d≤10.70, 3.91≤e≤4, 0≤f≤0.09).

1. he solid electrolyte composition of claim 1, wherein the space group of the material represented by [Equation 1] above 143 m.

3. The solid electrolyte composition of claim 1, wherein the material represented by [Equation 1] above has an ionic conductivity σion at room temperature (25° C.) of 15.0 mS/cm or greater.

4. The solid electrolyte composition of claim 1, wherein the material represented by [Equation 1] above has an ionic conductivity σion at a low temperature (−20° C.) of 3.5 mS/cm or greater.

5. The solid electrolyte composition of claim 1, wherein in the material represented by [Equation 1] above, a is 2.87 to 2.89, f is 0.

6. The solid electrolyte composition of claim 1, wherein the crystal structure of the material represented by [Equation 1] above is cubic.

7. A method for preparing a solid electrolyte composition including a material represented by [Equation 1] below, the method comprising:
(a) mixing raw materials;
(b) heating the mixed materials to a predetermined temperature and maintaining the same for a predetermined period of time; and
(c) cooling the heated materials:
NaₐW_{b}Si_{c}Sb_{d}SₑBr_{f} [Equation 1]
(wherein, 2.80≤a≤2.89, 0.20≤b≤0.24, 0.08≤c≤0.12, 0.66≤d≤10.70, 3.91≤e≤4, 0≤f≤0.09).

8. The method of claim 7, wherein the step (b) above is performed at 275° C. to 575° C. for 12 hours to 48 hours.
